(19) United States
(12) Patent Application Publication
(10) Pub. No.: US 2020/0110887 A1
(43) Pub. Date: Apr. 9, 2020

(54) PROTECTING DISPLAYED DATA BY ENCRYPTING PIXELS

(71) Applicant: CA, Inc., New York, NY (US)

(72) Inventors: Sharath Kumar, Bangalore (IN); Stephen Prasad, Bangalore (IN); Ambrish Pandey, Bangalore (IN); Anil Joseph, Bangalore (IN); Koppula Shalem Raju, Bangalore (IN)

(73) Assignee: CA, Inc., New York, NY (US)

(21) Appl. No.: 16/155,250

(22) Filed: Oct. 9, 2018

(51) Int. Cl. G06F 21/60; H04L 29/06; G06F 21/62; G06F 21/44; H04L 9/08; G06T 11/60; G09G 5/12

(52) U.S. Cl. CPC G06F 21/602; H04L 63/0435; G06F 21/606; G06F 21/6245; G06F 21/44; H04L 63/0492; G09G 2370/022; H04L 9/083; G06T 11/60; G09G 5/12; G09G 2358/00; G09G 2340/12; H04L 63/0884

(57) ABSTRACT

A system for protecting displayed data by encrypting pixels can include a user interface, a communication interface, a processing circuit, and memory. The memory can have instructions stored therein that are executable by the processing circuit for causing the processing circuit to obtain an encryption key associated with an account. The processing circuit can further determine sensitive data that is associated with the account and an array of pixels that is usable to display the sensitive data. The processing circuit can further encrypt the array of pixels based on the encryption key associated with the account to generate an encrypted array of pixels. The processing circuit can further display, via the user interface, the encrypted array of pixels. A displayed version of the encrypted array of pixels being decryptable using the encryption key to determine the sensitive data by a remote device associated with the account.

### TECHNICAL FIELD

The present disclosure relates to computing systems, and, in particular, to a computer system for protecting displayed data by encrypting pixels.

### BACKGROUND

As the speed, ease, and volume of electronically transmitted data increases, there becomes a greater need for systems to protect sensitive data. Sensitive data can include personally identifiable information (e.g., a name, an address, or a social security number) as well as other private information (e.g., a salary, a grade, an account balance). A malicious entity may attempt to obtain sensitive data related to a user and use the sensitive data such that the user is financially or socially damaged.

Some protections have been instituted for protecting the data in its electronic form. For example, some systems encrypt data during electronic transfer to prevent malicious entities from intercepting and accessing the data. However, vulnerabilities remain in these systems that can allow malicious entities to access sensitive data. In some examples, sensitive data can be encrypted by a remote server and securely transferred to a second device. The second device can decrypt the transmitted data and display the decrypted sensitive data to a user. However, malicious entities may intercept the decrypted sensitive data when it is being displayed by the second device to the user.

### SUMMARY

Some embodiments disclosed herein are directed to a system for protecting displayed data. The system can include a user interface, a communication interface, a processing circuit, and memory. The user interface can display pixels in a two-dimensional array. Each of the pixels can have a unique position in the two-dimensional array. The memory can have instructions stored therein that are executable by the processing circuit for causing the processing circuit to obtain an encryption key associated with an account. The instructions are further executable for causing the processing circuit to determine sensitive data that is associated with the account. The instructions are further executable for causing the processing circuit to determine an array of pixels that is usable to display the sensitive data. The array of pixels can have associated unique positions in the two-dimensional array. The instructions are further executable for causing the processing circuit to encrypt the array of pixels that is usable to display the sensitive data based on the encryption key associated with the account to generate an encrypted array of pixels having the associated unique positions in the two-dimensional array. The instructions are further executable for causing the processing circuit to display, via the user interface, the encrypted array of pixels at the associated unique positions in the two-dimensional array. A displayed version of the encrypted array of pixels can be decryptable using the encryption key to determine the sensitive data by a remote device associated with the account.

Other embodiments disclosed herein are directed to a method. The method can include obtaining, by a user device, an encryption key associated with a user account. The method can further include capturing, by a camera of the user device, an image of a remote display that is physically separate from the user device. The image can depict a portion of the remote display that includes an encrypted array of pixels. The encrypted array of pixels can correspond to sensitive data associated with the user account. The method can further include decrypting, by the user device, the encrypted array of pixels using the encryption key associated with the user account to determine a decrypted array of pixels. The method can further include displaying, by a user interface of the user device, the decrypted array of pixels.

Corresponding operations by computer program products and electronic devices are disclosed. Other methods, computer program products, and electronic devices according to embodiments will be or become apparent to one with skill in the art upon review of the following drawings and detailed description. It is intended that all such additional methods, computer program products, and electronic devices be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Aspects of the present disclosure are illustrated by way of example and are not limited by the accompanying drawings. In the drawings:

FIG. 1 is a block diagram of an example of a system for protecting displayed data by encrypting pixels in accordance with some embodiments of the present disclosure;

FIG. 2 is a block diagram of an example of a user device for displaying data to a user based on encrypted pixels in accordance with some embodiments of the present disclosure;

FIG. 3 is a perspective view of an example of a user device for displaying data to a user based on encrypted pixels in accordance with some embodiments of the present disclosure;

FIG. 4 is a block diagram of an example of a display device for protecting displayed data by encrypting pixels in accordance with some embodiments of the present disclosure;

FIG. 5 is a block diagram of an example of an account server for associating encryption keys with user accounts for protecting displayed data by encrypting pixels in accordance with some embodiments of the present disclosure;

FIG. 6 is a flow chart of an example of a process for protecting displayed data by encrypting pixels in accordance with some embodiments of the present disclosure; and

FIG. 7 is a flow chart of an example of a process for displaying data to a user based on encrypted pixels in accordance with some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components, and circuits have not been described in detail so as not to obscure the present invention. It is intended that all embodiments disclosed herein can be implemented separately or combined in any way and/or combination.

As explained above, malicious entities may attempt to obtain sensitive data associated with a user and can use the obtained sensitive data to financially or socially harm the user. Various embodiments of the present disclosure are direct to protecting displayed data by encrypting pixels. In some examples, data displayed on a screen can be encrypted at the pixel level. Format preserving encryption (“FPE”) can be used to encrypt an array of pixels such that the pixels rendered on the screen are jumbled. A user associated with the data may look at the screen using a user device (e.g., a mobile device). The user device can have access to the same FPE key used to encrypt array of pixels and can decrypt an image of the encrypted array of pixels and display an image with the unencrypted array of pixels such that the data is readable from the user device.

Some embodiments of the present disclosure can provide various improvements to the field of data security and data encryption. Protecting displayed data using encrypted pixels can reduce the chance of a malicious entity gaining access to sensitive data. In addition, protecting displayed data by encrypting pixels can reduce the amount of encrypted data transmitted to a user device.

Furthermore, some embodiments of the present disclosure allow for faster generation of translated versions of UIs. For example, the video of navigation through the UI can be automatically captured and packaged with an untranslated resource bundle, and a single video file can be transmitted per translation request. A translated resource bundle can be received and automatically used to generate a translated version of the user interface. Additionally, in some embodiments, the processing resources and transmission bandwidth can be reduced by automatically reducing the frame rate or resolution for part of the video based on detecting duplicate frames.

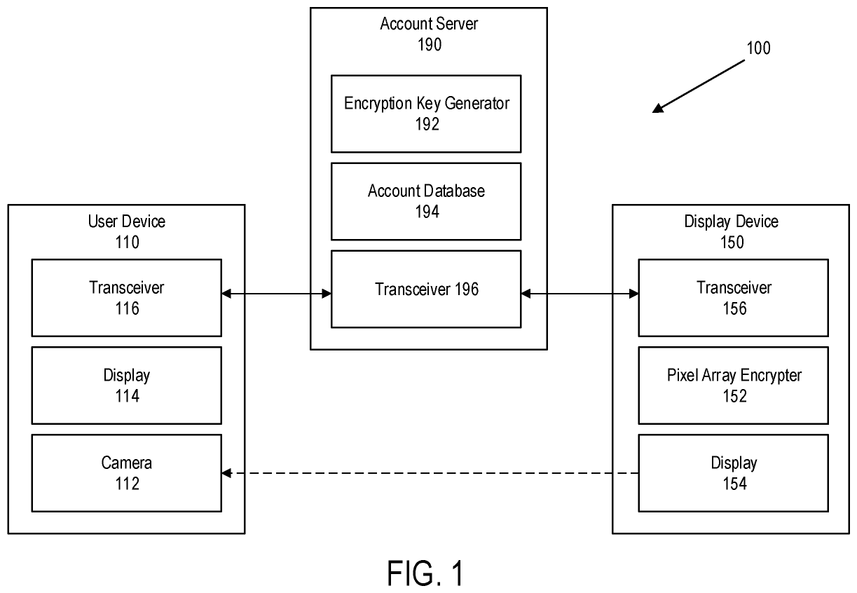

FIG. 1 depicts an example of a system 100 for protecting displayed data by encrypting pixels in accordance with some embodiments of the present disclosure. In this example, the system includes a display device 150 and an account server 190. The account server 190 can be communicatively coupled to the display device 150 and a user device 110.

The account server 190 can include an encryption key generator 192, account database 194, and a transceiver 196. The transceiver 196 can include a transmitter and a receiver for communicating with the user device 110 and the display device 150. The account database 194 can include information associated with user accounts for different users including a user associated with the user device 110. The encryption key generator 192 can generate an encryption key that is usable to perform FPE to an array of pixels. An encryption key generated by the encryption key generator 190 can be associated with a specific user account, for example, the user account associated with the user of the user device 110. In some examples, the key can be stored in the account database 194. In additional or alternative examples, the key can be transmitted, via transceiver 196, to the user device 110 and the display device 150.

The display device 150 can include a pixel array encrypter 152, a display 154, and a transceiver 156. The transceiver 156 can include a transmitter and a receiver for communicating with the account server 190. The transceiver 156 may receive an encryption key associated with a user of the user device from the account server 190. The pixel encrypter 152 may encrypt an array of pixels displayable by the display 154 based on the encryption key. The display 154 can display the encrypted array of pixels.

In some embodiments, the display device 150 encrypts, via pixel array encrypter 152, an array of pixels corresponding to sensitive data associated with a user of the user device 110 using the encryption key associated with the user of the user device 110. Encrypting the array of pixels can prevent malicious entities from obtaining the sensitive data by viewing the display 154.

The user device 110 can include a camera 112, a display 114, and a transceiver 116. The camera 112 can be used to capture an image of a portion of the display 154. In some examples, the user device 110 captures a portion of the display 154 that includes an encrypted array of pixels. The user device 110 can receive the encryption key, via transceiver 116, from the account server 190 and use the encryption key to decrypt the encrypted array of pixels captured in the image. The display 114 can be used to display a decrypted version of the array of pixels to the user.

Although FIG. 1 depicts the account server 190 as separate and independent from the display device 150, other implementations are possible. In some embodiments, a display device can include an account server or can include an encryption key generator and an account database. The display device may include a transceiver for communicating directly with a user device. In additional or alternative examples, the transceiver 156 may only include a receiver for receiving electrical signals from the account server 190 or the user device 110. In some embodiments, an encryption key generator can be included in the user device 110 and the display device 150 may receive, via transceiver 156, the encryption key from the user device 110.

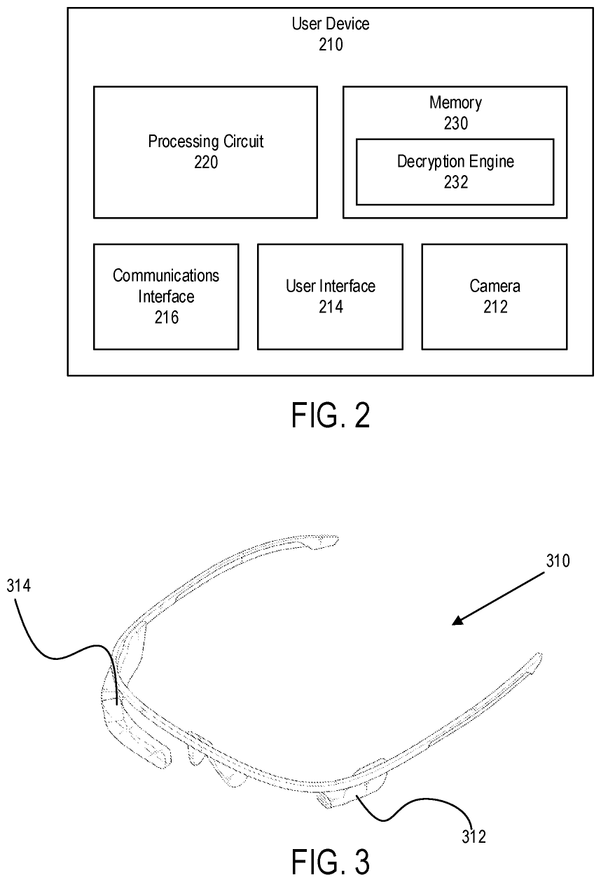

FIG. 2 depicts an example of a user device for displaying data to a user based on encrypted pixels in accordance with some embodiments of the present disclosure. In some embodiments the user device 210 is an example of the user device 110 in FIG. 1. The user device 210 can include a camera 212, user interface 214, communication interface 216, processing Circuit 220, and memory 230.

The processing circuit 220 may include one or more data processing circuits, such as a general purpose and/or special purpose processor (e.g., microprocessor and/or digital signal processor) that may be collocated within the user device 210 or distributed across one or more networks. The processing circuit 220 is configured to execute computer program code, for example decryption engine 230, in the memory 230, described below as non-transitory computer readable medium, to perform at least some of the operations described herein as being performed by the user device 210 or any component thereof.

The communication interface 216 may be a wired network interface transceiver, e.g., Ethernet, and/or a wireless radio frequency transceiver that is configured to operate according to one or more communication protocols, e.g., WiFi, Bluetooth, cellular, LTE, etc. The communication interface 216 can be communicatively coupled to a display device and/or an account server. In some embodiments, the user device 210 receives, via the communication interface 216, an encryption key from a display device or an account server. In additional or alternative embodiments, the user device 210 generates an encryption key and transmits, via the communication interface 216, the encryption key to a display device.

The camera 212 can include any suitable device for capturing an encrypted array of pixel from a display. In some examples, the camera 212 can include a video camera for capturing a video of a display.

The user interface 214 can include any suitable output device for displaying information to a user of the user device 210. In some embodiments, the user interface 214 includes a display (e.g., a LED screen of a mobile device) for displaying a decrypted version of the array of pixels that represent sensitive data associated with a user of the user device. In some examples, the user interface 214 can display the image captured by the camera 212 with the portion of the image depicting the encrypted array of pixels replaced by a decrypted version of the array of pixels. In additional or alternative embodiments, the user interface 214 can include a speaker for outputting audio content based on a decrypted version of the array of pixels.

FIG. 3 depicts an example of a perspective view of a user device 310 for displaying data to a user based on encrypted pixels in accordance with some embodiments of the present disclosure. In some embodiments, the user device 310 is an example of the user device 210 in FIG. 2. In this example, the user device 310 is a computer-generated reality (“CGR”) device having a camera 312 and a user interface 314.

The camera 312 can capture an image or video of real world objects. The user interface 314 can be partially transparent to allow a user to see the real-world objects through the user interface 314 and the user interface 314 can display computer-generated objects visible to the user. In additional or alternative examples, the user interface 314 can include a display for displaying an image of the real-world objects as well as the computer-generated objects.

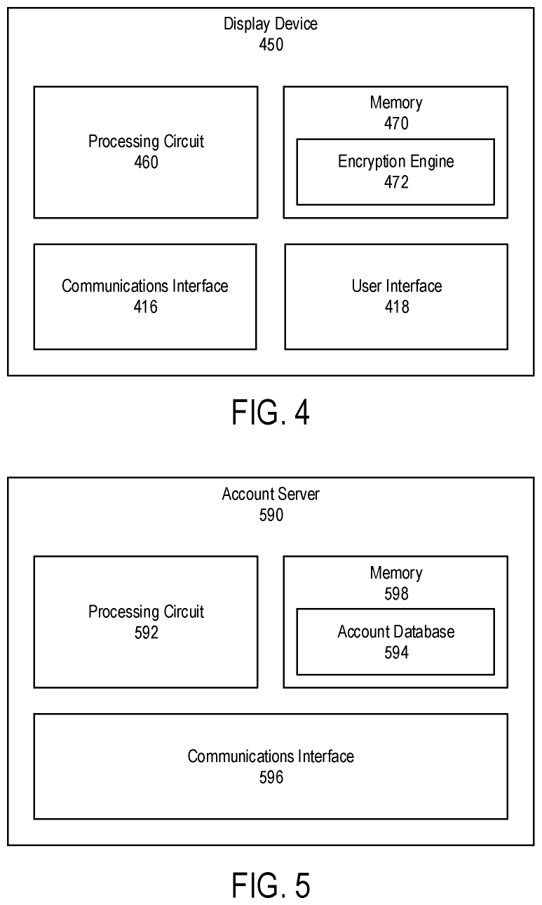

FIG. 4 depicts an example of a display device for protecting displayed data by encrypting pixels in accordance with some embodiments of the present disclosure. In some embodiments the display device 450 is an example of the display device 150 in FIG. 1. The display device 450 can include a communication interface 416, a user interface 418, processing circuit 460, and memory 470.

The communication interface 416 may be a wired network interface transceiver, e.g., Ethernet, and/or a wireless radio frequency transceiver that is configured to operate according to one or more communication protocols, e.g., WiFi, Bluetooth, cellular, LTE, etc. In some embodiments, the communication interface 416 can be communicatively coupled to a user device or an account server for receiving an encryption key.

The user interface 418 can include a display device for displaying a two-dimensional array of pixels. Each of the pixels can have an associated unique position on the display.

The processing circuit 460 may include one or more data processing circuits, such as a general purpose and/or special purpose processor (e.g., microprocessor and/or digital signal processor) that may be collocated within the display device 450 or distributed across one or more networks. The processing circuit 460 is configured to execute computer program code, for example encryption engine 472, in the memory 470, described below as non-transitory computer readable medium, to perform at least some of the operations described herein as being performed by the display device 450 or any component thereof.

In some embodiments, the display device 450 can obtain sensitive data that is associated with a user account. For example, the sensitive data can be received, via communication interface 416, as part of encrypted data from a remote device and can be obtained by decrypting the encrypted data. The display device 450 can determine an array of pixels to be used by the user interface 418 to display the sensitive data. The display device 450 can encrypt the array of pixels based on an encryption key associated with a user account of the user associated with the sensitive data to form an encrypted array of pixels corresponding to the sensitive data. The display device 450 can display, via the user interface 418, the encrypted array of pixels that may be decryptable using the encryption key to determine the sensitive data.

In additional or alternative embodiments, the display device 450 can detect that a user device associated with a user is within a threshold distance of the display device 450. In some examples, the display device 450 can receive, via communications interface 416, a signal from the user device indicating the user device is within the threshold distance. The signal can further include information identifying a user account of a user associated with the user device. In additional or alternative examples, the display device 450 can receive, via user interface 418, information from a user of the user device indicating the user device is within the threshold distance. The display device 450 can determine an encryption key associated with the user account of the user in response to detecting that the user device associated with the user is within the threshold distance of the display device 450. In addition, the display device 450 can display, via the user interface 418, a two-dimensional array of pixels including the encrypted array of pixels in response to detecting that the user device associated with the user is within the threshold distance of the display device 450.

FIG. 5 depicts an example of an account server 590 for associating encryption keys with user accounts for protecting displayed data by encrypting pixels in accordance with some embodiments of the present disclosure. In some embodiments the account server 590 is an example of the account server 190 in FIG. 1. The account server 590 can include a processing circuit 592, memory 598, and a communication interface 596.

The processing circuit 592 may include one or more data processing circuits, such as a general purpose and/or special purpose processor (e.g., microprocessor and/or digital signal processor) that may be collocated within the account server 590 or distributed across one or more networks. The processing circuit 592 is configured to execute computer program code in the memory 590, described below as non-transitory computer readable medium, to perform at least some of the operations described herein as being performed by the account server 590 or any component thereof. The memory 598 can further include an account database 594 for storing user accounts and corresponding information.

In some embodiments, the processing circuit 592 generates an encryption key associated with a user account. The encryption key can be stored in the account database 594 as associated with a specific user account.

The communication interface 596 may be a wired network interface transceiver, e.g., Ethernet, and/or a wireless radio frequency transceiver that is configured to operate according to one or more communication protocols, e.g., WiFi, Bluetooth, cellular, LTE, etc. In some embodiments, the communication interface 596 can be communicatively coupled to a user device and a display device such that an encryption key can be transmitted to both the user device and the display device.

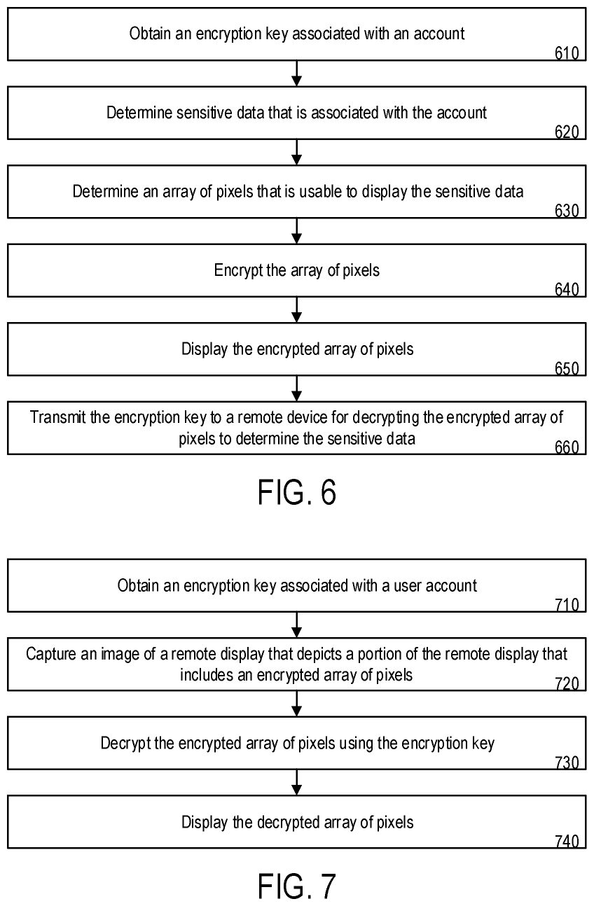

FIG. 6 depicts an example of a process for protecting displayed data by encrypting pixels in accordance with some embodiments of the present disclosure. The process is described below in reference to the display device 450 depicted in FIG. 4, but other implementations are possible.

In block 610, processing circuit 460 obtains an encryption key associated with an account. In some embodiments, the account is a user account associated with a user. The processing circuit 460 may receive, via user interface 418, information or account data from the user of the user account. In some examples, the processing circuit 460 may determine the user account associated with the user based on the information from the user. The processing circuit 460 may request and receive, via communication interface 416, the encryption key from an account server (e.g., account server 590 in FIG. 5) or may retrieve the encryption key from an account database within the display device 450.

In block 620, processing circuit 460 determines sensitive data that is associated with the account. In some embodiments, the processing circuit 460 may receive, via user interface 418, a request from the user to display information or account data associated with the user. The processing circuit 460 may communicate with a database or remote device to obtain the information. The processing circuit 460 may parse the information to identify the sensitive data within the information.

In block 630, processing circuit 460 determines an array of pixels that are usable to display the sensitive data. The user interface 418 may include a display for displaying pixels in a two-dimensional array. Each pixel in the two-dimensional array may have a unique position in the two-dimensional array. In some embodiments, the processing circuit 460 determines the array of pixels that are usable to display the sensitive data by determining the unique positions associated with each pixel of an array of pixels that can be used, by the user interface 418, to display the sensitive data.

In block 640, processing circuit 460 encrypts the array of pixels. The processing circuit 460 can encrypt the array of pixels to generate an encrypted array of pixels. The processing circuit 460 can encrypt the array of pixels using a FPE technique such that the size and dimensions of the encrypted array of pixels are the same as the array of pixels. For example, each of the unique positions in the two-dimensional array that are associated with the array of pixels can be associated with a pixel in the encrypted array of pixels. In some examples, the dimension of the array of pixels can include a resolution, color depth, or other format parameter. In some embodiments, the processing circuit 460 encrypts the array of pixels such that a quantity or number of pixels in the encrypted array of pixels is the same as the quantity of pixels in the array of pixels.

In block 650, processing circuit 460 displays, via user interface 418, the encrypted array of pixels. In some embodiments, the processing circuit 460 displays the two-dimensional array of pixels including the encrypted array of pixels. In some examples, the processing circuit 460 displays, via user interface 418, an identifier or flag in the two-dimensional array at a predetermined position relative to the encrypted array of pixels. The identifier or flag can indicate a location and size of the encrypted array of pixels within the two-dimensional array of pixels.

In block 660, the encryption key is transmitted to a remote device for decrypting the encrypted array of pixels to determine the sensitive data. In some embodiments, the processing circuit 460 transmits, via communication interface 416, the encryption key to the remote device. In additional or alternative embodiments, a remote account server transmits the encryption key to the remote device. In some examples, the processing circuit 460 transmits, via communication interface 416, a request to the remote account server to transmit the encryption key to the remote device. In additional or alternative embodiments, the encryption key can be received from the remote device or the remote account server. In additional or alternative embodiments, the encryption key can be generated by the processing circuit 460 using an algorithm that is shared with the remote device such that the remote device can generate the encryption key as well.

Various operations from the flow chart of FIG. 6 may be optional with respect to some embodiments and related methods. For example, some processes may exclude the operations in block 660 and instead the encryption key may be received from the remote device. Additionally or alternatively, the operations from the flow chart of FIG. 6 may be performed in any suitable order.

FIG. 7 depicts an example of a process for displaying data to a user based on encrypted pixels in accordance with some embodiments of the present disclosure. The process is described below in reference to the user device 210 depicted in FIG. 2, but other implementations are possible.

In block 710, processing circuit 220 obtains an encryption key associated with a user account. In some examples, the user device 210 may receive the encryption key. In additional or alternative examples, the user device 210 may receive the encryption key in response to authenticating that the user device is associated with a specific user or a user account associated with the specific user. The encryption key may be unique the user. In some embodiments, the user device 210 generates the encryption key and transmits the encryption key to a remote display.

In block 720, processing circuit 220 captures, via camera 212, an image of a remote display that depicts a portion of the remote display that includes an encrypted array of pixels. The remote display may be physically separate from the user device 210 and the encrypted array of pixels may correspond to sensitive data associated with a user of the user device 210.

In block 730, processing circuit 220 decrypts the encrypted array of pixels using the encryption key. In some embodiments, processing circuit 220 decrypts the encrypted array of pixels using an encryption key based on a format-preserving encryption technique such that a dimension of the decrypted array of pixels is the same as a dimension of the encrypted array of pixels. In some examples, a quantity of the pixels in the decrypted array of pixels may be the same as a quantity of pixels in the encrypted array of pixels.

In block 740, processing circuit 220 displays, via user interface 214, the decrypted array of pixels. In some embodiments, the user device 210 includes a CGR device that generates a CGR by displaying the image with a computer-generated image of the decrypted array of pixels overlaid on the image. In additional or alternative embodiments, the user device 210 can include a semi-transparent display such that the user can see the remote display through the semi-transparent display and a computer-generated image of the decrypted array of pixels is positioned on the semi-transparent display.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A system for protecting displayed data, the system comprising:
a user interface for displaying a plurality of pixels in a two-dimensional array, each pixel of the plurality of pixels having a unique position in the two-dimensional array;
a communication interface;
a processing circuit; and
memory having instructions stored therein that are executable by the processing circuit for causing the processing circuit to:
obtain an encryption key associated with an account;
determine sensitive data that is associated with the account;
determine an array of pixels of the plurality of pixels that is usable to display the sensitive data, the array of pixels of the plurality of pixels having an associated plurality of unique positions in the two-dimensional array;
encrypt the array of pixels of the plurality of pixels that is usable to display the sensitive data based on the encryption key associated with the account to generate an encrypted array of pixels having the associated plurality of unique positions in the two-dimensional array; and
display, via the user interface, the encrypted array of pixels at the associated plurality of unique positions in the two-dimensional array, a displayed version of the encrypted array of pixels being decryptable using the encryption key to determine the sensitive data by a remote device associated with the account.

2. The system of claim 1, wherein causing the processing circuit to obtain the encryption key associated with the account comprises causing the processing circuit to generate the encryption key for a format-preserving encryption technique,
wherein causing the processing circuit to encrypt the array of pixels of the plurality of pixels that is usable to display the sensitive data comprises causing the processing circuit to encrypt the array of pixels of the plurality of pixels using the encryption key and the format-preserving encryption technique such that a dimension of the encrypted array of pixels is the same as a dimension of the array of pixels of the plurality of pixels.

3. The system of claim 1, wherein causing the processing circuit to encrypt the array of pixels of the plurality of pixels that is usable to display the sensitive data comprises causing the processing circuit to encrypt the array of pixels of the plurality of pixels such that a quantity of pixels in the encrypted array of pixels is the same as a quantity of pixels in the array of pixels of the plurality of pixels.

4. The system of claim 1, wherein causing the processing circuit to determine the sensitive data that is associated with the account comprises causing the processing circuit to:
receive, via the communication interface, account data comprising the sensitive data; and
parse the account data to determine the sensitive data,
wherein causing the processing circuit to display the encrypted array of pixels at the associated plurality of unique positions in the two-dimensional array comprises causing the processing circuit to:
display, via the user interface, a portion of the account data comprising the sensitive data; and
display, via the user interface, a flag at a position in the two-dimensional array relative to the unique positions in the two-dimensional array that indicates the unique positions of the two-dimensional array to the remote device.

5. The system of claim 1, wherein causing the processing circuit to encrypt the array of pixels of the plurality of pixels that is usable to display the sensitive data comprises causing the processing circuit to encrypt the array of pixels of the plurality of pixels using the encryption key independent of content associated with the sensitive data.

6. The system of claim 1, wherein the instructions are further executable by the processing circuit for causing the processing circuit to transmit, via the communication interface, the encryption key associated with the account to the remote device associated with the account, the encryption key usable by the remote device for decrypting the encrypted array of pixels to determine the sensitive data.

7. The system of claim 6, wherein causing the processing circuit to transmit the encryption key associated with the account to the remote device associated with the account comprises causing the processing circuit to:
receive, via the communication interface, a request from the remote device to assign a unique encryption key to the account;
authenticate that the remote device is associated with the account; and
responsive to authenticating that the remote device is associated with the account, causing the processing circuit to transmit, via the communication interface, the encryption key to the remote device prior to causing the processing circuit to display encrypted array of pixels at the associated plurality of unique positions in the two-dimensional array.

8. The system of claim 1, wherein the instructions stored therein that are further executable by the processing circuit for causing the processing circuit to:
detect the remote device is within a threshold distance of the user interface;
receive an identifier of the remote device from the remote device;
transmit, via the communication interface, the identifier to a remote account server; and
receive, via the communication interface, the encryption key and confirmation that the remote device is associated with the account.

9. A method for protecting displayed data, the method comprising:
obtaining an encryption key associated with an account;
determining sensitive data that is associated with the account;
determining an array of pixels of a plurality of pixels that is usable to display the sensitive data that is associated with the account, the plurality of pixels being displayable in a two-dimensional array on a display, the array of pixels of the plurality of pixels having a unique position within the two-dimensional array;
encrypting the array of pixels of the plurality of pixels that is usable to display the sensitive data based on the encryption key associated with the account to generate an encrypted array of pixels, the encrypted array of pixels having the unique position in the two-dimensional array;
displaying the encrypted array of pixels at the unique position in the two-dimensional array, a displayed version of the encrypted array of pixels being decryptable using the encryption key to determine the sensitive data by a remote device associated with the account.

10. The method of claim 9, wherein obtaining the encryption key associated with the account comprises generating the encryption key for a format-preserving encryption technique,
wherein encrypting the array of pixels of the plurality of pixels that is usable to display the sensitive data comprises encrypting the array of pixels of the plurality of pixels using the encryption key and the format-preserving encryption technique such that a dimension of the encrypted array of pixels is the same as a dimension of the array of pixels of the plurality of pixels.

11. The method of claim 9, wherein encrypting the array of pixels of the plurality of pixels that is usable to display the sensitive data comprises encrypting the array of pixels of the plurality of pixels such that a quantity of pixels in the encrypted array of pixels is the same as a quantity of pixels in the array of pixels of the plurality of pixels.

12. The method of claim 9, wherein determining the sensitive data that is associated with the account comprises:
receiving account data comprising the sensitive data; and
parsing the account data to determine the sensitive data,
wherein displaying the encrypted array of pixels at the unique position in the two-dimensional array comprises:
displaying a portion of the account data comprising the sensitive data; and
displaying a flag at a position in the two-dimensional array relative to the unique position in the two-dimensional array to the remote device.

13. The method of claim 9, wherein encrypting the array of pixels of the plurality of pixels that is usable to display the sensitive data comprises encrypting the array of pixels of the plurality of pixels using the encryption key independent of content associated with the sensitive data.

14. The method of claim 9, further comprising transmitting the encryption key associated with the account to the remote device associated with the account, the encryption key being usable by the remote device for decrypting the encrypted array of pixels to determine the sensitive data.

15. The method of claim 14, wherein transmitting the encryption key associated with the account to the remote device associated with the account comprises:
receiving a request from the remote device to assign a unique encryption key to the account;
authenticating the remote device is associated with the account; and
responsive to authenticating that the remote device is associated with the account, transmitting the encryption key to the remote device prior to causing the processing circuit to display encrypted array of pixels at the associated plurality of unique positions in the two-dimensional array.

16. The method of claim 9, further comprising:
detecting the remote device is within a threshold distance of the user interface;
receiving an identifier of the remote device from the remote device;
transmitting the identifier to a remote account server; and
receiving the encryption key and confirmation that the remote device is associated with the account.

17. A method comprising:
obtaining, by a user device, an encryption key associated with a user account;
capturing, by a camera of the user device, an image of a remote display that is physically separate from the user device, the image depicting a portion of the remote display comprising an encrypted array of pixels, the encrypted array of pixels corresponding to sensitive data associated with the user account;
decrypting, by the user device, the encrypted array of pixels using the encryption key associated with the user account to determine a decrypted array of pixels; and
displaying, by a user interface of the user device, the decrypted array of pixels.

18. The method of claim 17, wherein obtaining the encryption key comprises:
authenticating, by the user device, that the user device is associated with the user account; and
responsive to authenticating that the user device is associated with the user account, receiving, by the user device, the encryption key.

19. The method of claim 17, wherein displaying the decrypted array of pixels comprises generating a computer-generated reality by displaying the image with a computer-generated image of the decrypted array of pixels overlaid on the image.

20. The method of claim 17, wherein decrypting the encrypted array of pixels using the encryption key associated with the user account comprises decrypting the encrypted array of pixels using the encryption key based on a format-preserving encryption technique such that a dimension of the decrypted array of pixels is the same as a dimension of the encrypted array of pixels and such that a quantity of pixels in the decrypted array of pixels is the same as a quantity of pixels in the encrypted array of pixels.
